(19) United States
(12) Patent Application Publication
(10) Pub. No.: US 2011/0016684 A1
(43) Pub. Date: Jan. 27, 2011

(54) Special tool used in a control arm of vehicles

(76) Inventor: Chen Jun Fan, Taichung City (TW)

Correspondence Address: CHEN JUN FAN, 5F-2, No. 212, Sec. 1, Wunsin Rd.,, Taichung City, 408, TW

(21) Appl. No.: 12/583,246

(22) Filed: Aug. 18, 2009

(30) Foreign Application Priority Data
Jul. 24, 2009 (TW) 098213592

(51) Int. Cl. B25B 27/14

(52) U.S. Cl. 29/278; 254/131

(57) ABSTRACT

A special tool used in a control arm of vehicles comprises a rod to be held by hand formed in an elongated stick shape and including a lower end having a retaining portion to abut against a bottom side of the control arm, and between the rod and the retaining portion being defined a support portion; a suspending seat including a lateral slot secured at a side thereof to engage with the support portion; an engaging member connected to the suspending seat so as to hook the control arm of vehicle.

### BACKGROUND OF THE INVENTION

1. Field of the Invention

The present invention relates to a tool used in vehicles maintenance, and more particularly to a special tool used to disassemble various control arms of vehicles.

2. Description of the Prior Art

Conventional special tool to disassemble control arms of vehicles includes an elongated rod with a raised distal end to abut against a bottom side of the control arm. The distal end is welded a U-shaped suspending seat to hook the control arm so that a knob on one end of the control arm to move downward to disengage from a socket of a speed shaft, disassembling control arm. However, the suspending seat is welded with the rod integrally that can not be adjusted to match with different control arms of vehicles.

The present invention has arisen to mitigate and/or obviate the afore-described disadvantages.

### SUMMARY OF THE INVENTION

The primary object of the present invention is to provide a special tool used in a control arm of vehicles that can save labor effectively and disassemble various controls easily.

Another object of the present invention is to provide a special tool used in a control arm of vehicles that the engaging member hooks the control securely.

A special tool used in a control arm of vehicles comprises:

a rod to be held by hand formed in an elongated stick shape and including a lower end having a retaining portion to abut against a bottom side of the control arm, and between the rod and the retaining portion being defined a support portion;

a suspending seat including a lateral slot secured at a side thereof to engage with the support portion;

an engaging member connected to the suspending seat so as to hook the control arm of vehicle;

wherein the lower end of the rod is bended to form a V shape and includes a retaining portion with a V-shaped cross section;

wherein the support portion is formed in an elongated piece shape, and the lateral slot of the suspending seat is formed in an elongated shape to correspond to the support portion;

wherein the suspending seat includes a connecting member attached thereon, a width of the connecting member is narrower than that of the lateral slot, and a side of the connecting member is surface milled to form a thinner thickness, the milled surface of the connecting member is a side recess including two adjusting bores to connect the connecting member with the engaging member, and the engaging member includes two ends, one end of the engaging member includes an axial groove extending from a bottom end of the engaging member to engage with the connecting member, a first end of the engaging member includes two through holes communicating with the groove so as to align with the adjusting bores and screwing with a bolt;

wherein the engaging member includes a locking notch to hook the control arm;

wherein another end of the engaging member is bended to form a U-shaped second end including the locking notch arranged on an inner side thereof so that the suspending seat hooks the control arm securely by using the locking notch.

### BRIEF DESCRIPTION OF THE DRAWINGS

FIG. 1 is a perspective view showing the assembly of a special tool used in a control arm of vehicles in accordance with a preferred embodiment of the present invention;

FIG. 2 is a perspective view showing the exploded components of the special tool used in the control arm of vehicles in accordance with the preferred embodiment of the present invention;

FIG. 3 is a side plan view showing the assembly of the special tool used in the control arm of vehicles in accordance with the preferred embodiment of the present invention;

FIG. 4 is a side plane view showing the suspending seat being adjusted in accordance with the preferred embodiment of the present invention;

FIG. 5 is another side plane view showing the operation of a control arm in accordance with the preferred embodiment of the present invention;

FIG. 6 is another side plane view showing the control arm being disassembled in accordance with the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

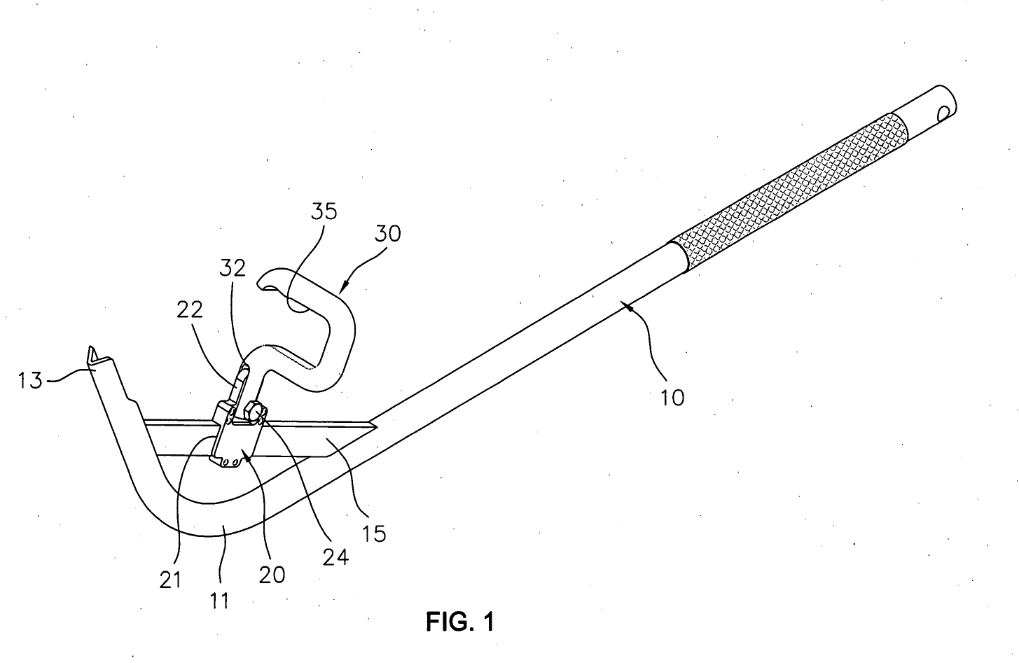

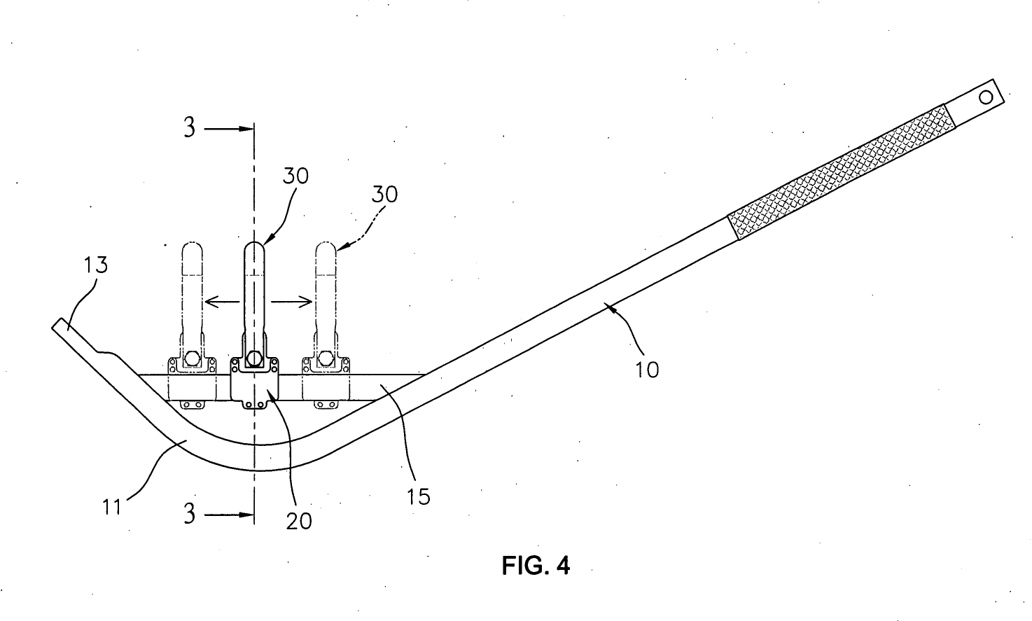

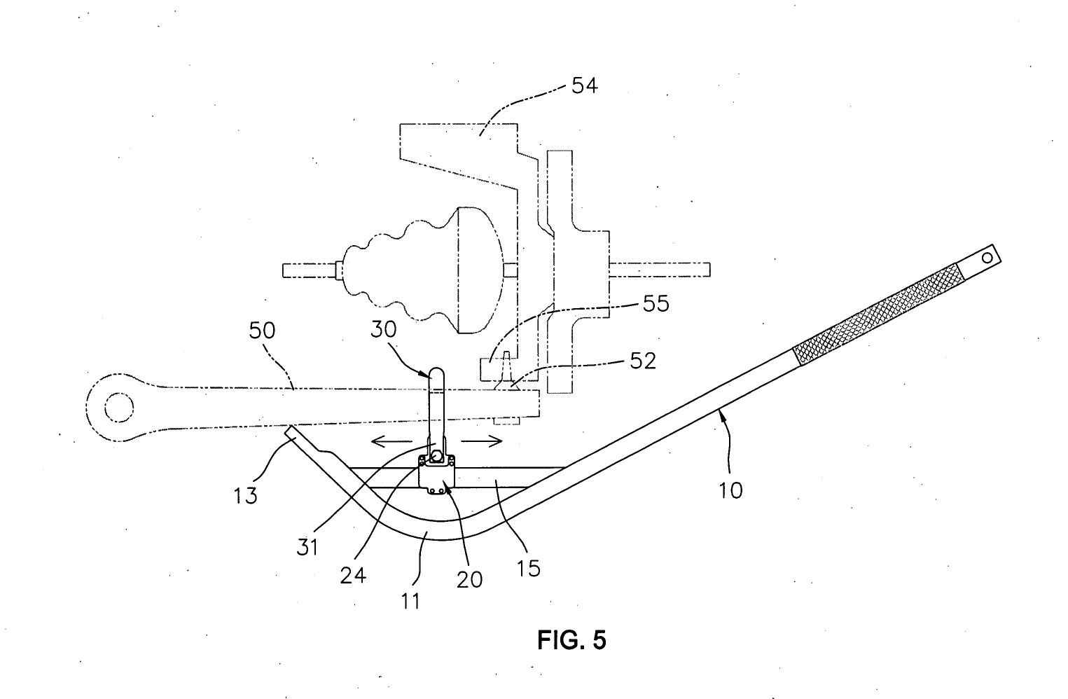

Referring to FIGS. 1-6, a special tool used in a control arm of vehicles in accordance with a preferred embodiment of the present invention comprises: a rod 10 to be held by hand, a movable suspending seat 20, and an engaging member 30 to engage the control arm 50 of the vehicles, wherein

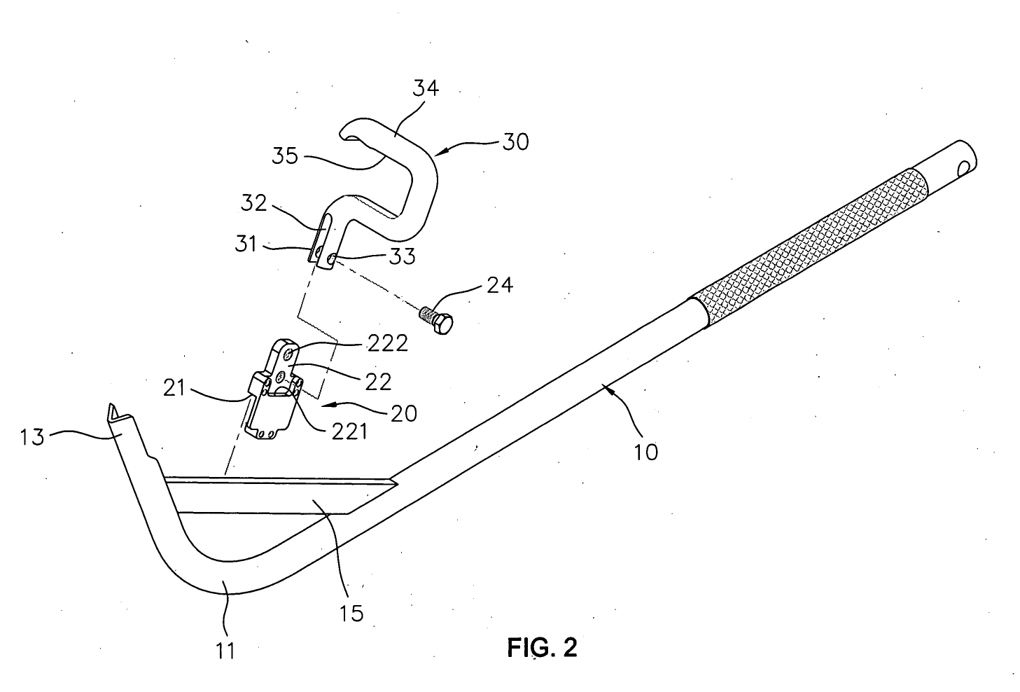

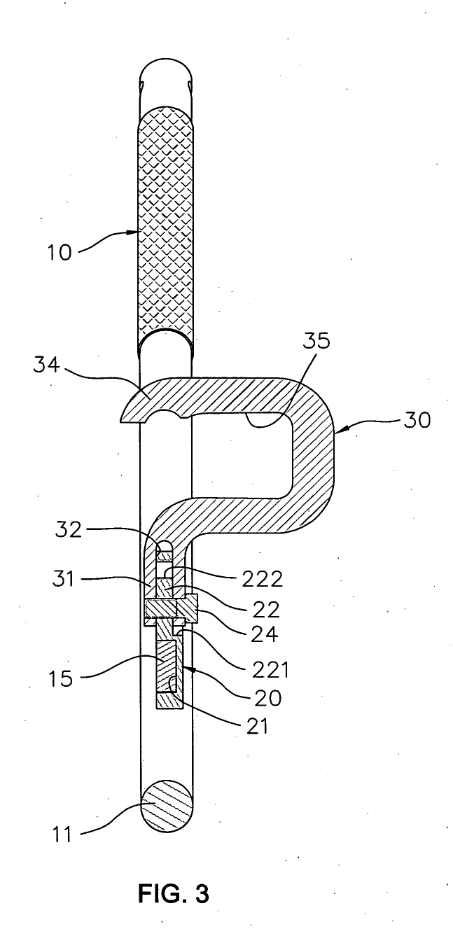

the rod 10 is formed in an elongated stick shape and includes a V-shaped lower end 11 having a retaining portion 13 with a V-shaped cross section to abut against a bottom side of the control arm 50 to generate a fulcrum. In addition, between the rod 10 and the retaining portion 13 is defined a support portion 15. As shown in FIGS. 2 and 3, the support portion 15 is formed in an elongated piece shape to position and move the suspending seat 20.

The suspending seat 20 is formed in an elongated shape to correspond to the support portion 15 and includes a lateral slot 21 secured at a side thereof to engage with the support portion 15, and includes a connecting member 22 attached thereon, a width of the connecting member 22 is narrower than that of the lateral slot 21, and a side of the connecting member 22 is surface milled to form a thinner thickness, the milled surface of the connecting member 22 is a side recess 221 including two adjusting bores 222 to connect the connecting member 22 with the engaging member 30.

The engaging member 30 is a curved cylinder and includes two ends, one end of the engaging member 30 includes an axial groove 32 extending from a bottom end of the engaging member 30 to engage with the connecting member 22, a first end 31 of the engaging member 30 includes two through holes 33 communicating with the groove 32 so as to align with the adjusting bores 222 and screwing with a bolt 24, such that the first end 31 of the engaging member 30 and the suspending seat 20 connect together. Another end of the engaging member 30 is bended to form a U-shaped second end 34 including a locking notch 35 arranged on an inner side thereof so that the suspending seat 20 hooks the control arm 50 securely by using the locking notch 35.

Thereby, the suspending seat 20 and the engaging member 30 move laterally along the support portion 15 by ways of the slot 21 to change a distance between the suspending seat 20 and the retaining portion 13.

As shown in FIGS. 3, 5, and 6, in the operation, the retaining portion 13 of the rod 10 abuts against the bottom side of the control arm 50 in a lateral direction, and the engaging member 30 hooks the control arm 50 by ways of the locking notch 35, the bolt 24 is lessen so that the engaging member 30 is adjusted to a suitable adjusting bore 222 based on a distance between the support member 15 and the control arm 50, and the suspending seat 20 is adjusted to move along the support portion 15 relative to the engaging member 30, the retaining portion 13, and a knob 52 so that the engaging member 30 is close to the knob 52 and is away from the retaining portion 13 to generate a long levering arm, obtaining labor saving effect.

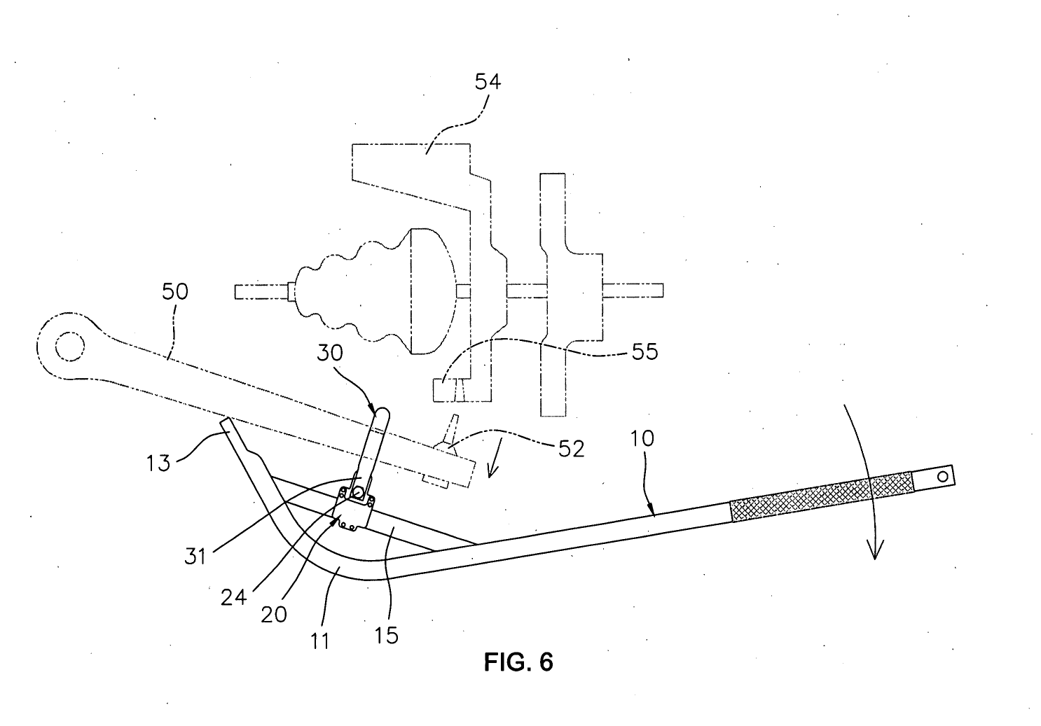

Thereafter, the lever strength is generated by pressing the rod 10 as illustrated in FIG. 6, and a labor saving effect is generated by abutting the rod 10 against the control arm 50 through the retaining portion 13 so that a torque forced on the rod 10 passes toward the suspending seat 20, such that the engaging member 30 drives the control arm 50 to move downward, hence the knob 52 disengages from a socket 55 of a joint 54, thereby saving labor and removing the control arm 50.

While we have shown and described various embodiments in accordance with the present invention, it is clear to those skilled in the art that further embodiments may be made without departing from the scope of the present invention.

What is claimed is:

1. A special tool used in a control arm of vehicles comprising:
a rod to be held by hand formed in an elongated stick shape and including a lower end having a retaining portion to abut against a bottom side of the control arm, and between the rod and the retaining portion being defined a support portion;
a suspending seat including a lateral slot secured at a side thereof to engage with the support portion;
an engaging member connected to the suspending seat so as to hook the control arm of vehicle.

2. The special tool used in a control arm of vehicles as claimed in claim 1, wherein the lower end of the rod is bended to form a V shape and includes a retaining portion with a V-shaped cross section.

3. The special tool used in a control arm of vehicles as claimed in claim 1, wherein the support portion is formed in an elongated piece shape, and the lateral slot of the suspending seat is formed in an elongated shape to correspond to the support portion.

4. The special tool used in a control arm of vehicles as claimed in claim 1, wherein the suspending seat includes a connecting member attached thereon, a width of the connecting member is narrower than that of the lateral slot, and a side of the connecting member is surface milled to form a thinner thickness, the milled surface of the connecting member is a side recess including two adjusting bores to connect the connecting member with the engaging member, and the engaging member includes two ends, one end of the engaging member includes an axial groove extending from a bottom end of the engaging member to engage with the connecting member, a first end of the engaging member includes two through holes communicating with the groove so as to align with the adjusting bores and screwing with a bolt.

5. The special tool used in a control arm of vehicles as claimed in claim 1, wherein the engaging member includes a locking notch to hook the control arm.

6. The special tool used in a control arm of vehicles as claimed in claim 4, wherein another end of the engaging member is bended to form a U-shaped second end including the locking notch arranged on an inner side thereof so that the suspending seat hooks the control arm securely by using the locking notch.
